(19) United States
(12) Patent Application Publication
(10) Pub. No.: US 2006/0021024 A1
(43) Pub. Date: Jan. 26, 2006

(54) User certification apparatus and user certification method

(75) Inventor: Hyun-cheol Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/084,795

(22) Filed: Mar. 21, 2005

(30) Foreign Application Priority Data
Jul. 10, 2004 (KR) 10-2004-0053782

(51) Int. Cl. G06F 12/14

(52) U.S. Cl. 726/17

(57) ABSTRACT

A user certification apparatus includes a user certification unit performing user certification based on a combined result of avatar elements which is indicated as identification information for identifying each avatar element and position information for indicating a position of each avatar element on a combined avatar image. Accordingly, the user can more easily remember the certification information, and it is difficult for others to misappropriate the certification information.

### BACKGROUND OF THE INVENTION

This application claims priority from Korean Patent Application No. 10-2004-0053782, filed on Jul. 10, 2004 in the Korean Intellectual Property Office, the disclosure of which is incorporated herein in its entirety by reference.

1. Field of the Invention

The present invention relates to a user certification apparatus and method.

2. Description of the Related Art

The rapid development of the Internet, wire/wireless communication lines, and personal computers allows users to enjoy shopping, playing games, and chatting on the Internet, as well as the use of electronic services. Moreover, with the rapid spread of portable personal terminals and the development of wireless environments, users can play games or make electronic payments through their portable personal terminals.

In this regard, the users should undergo a user certification process. That is, most service providers generally allow only certified users to use a service, without regard to whether the service is free.

FIG. 1 is a block diagram of a user certification apparatus 100 according to the prior art.

Referring to FIG. 1, the user certification apparatus 100 includes an input unit 110, an output unit 120, a processing unit 130, and a user certification information storage unit 140.

The input unit 110 is constructed to receive an ID (identification) and password to be used as user certification information from a user, and the output unit 120 is a device for displaying a user interface by which the user can input the ID and password. The output unit 120, which shows an input result of the user certification information, displays information about whether the user is certified or a request message to re-input the ID and password on a screen.

The processing unit 130 registers the user certification information and performs user certification. That is, the processing unit corresponds to a computing part, which is a typical central processing unit for processing input information in case of a local device or is a part including both a client and a server in case of a network.

A user certification information registration unit 131 stores the ID and password to be used as user certification information, which are provided from the input unit 110, in the user certification information storage unit 140. To certify a user who previously registered user certification information, the user certification unit 132 receives the user certification information, specifically, the ID and password entered by the user via input unit 110, compares the received user certification information with the ID and password previously stored in the user certification information storage unit 140, and performs the user certification based on the comparison.

The user certification information storage unit 140 stores IDs and passwords which users have already registered. In case of a local device, the user certification information storage unit 140 corresponds to an area of a storage medium such as a hard disk drive (HDD) and a random access memory (RAM), or in case of a network, it can be a server for managing a database located at a remote site.

FIG. 2 is a flowchart of a user certification process according to the prior art.

Referring to FIG. 2, the user certification unit 132 requests a user to input an ID and a password for the user certification (operation 201).

After the user certification unit 132 receives the ID and password from the user (operation 202), the user certification unit 132 compares the ID and password stored in the user certification information storage unit 140 with the received ID and password, respectively (operation 203).

Then, it is determined whether the respective IDs and passwords are identical with each other (operation 204), and if they are identical, the user certification is completed (operation 205) and the user is allowed to use a service. When the respective IDs and passwords are not identical with each other, the procedure goes back to the operation 201 in which the user is requested to input the ID and the password again.

In general, however, users already have as many IDs and passwords as the number of service providing sites they visit. Since a user is required to input an ID and password for user certification at every service providing site, the user should memorize all IDs and passwords for the service providing sites. Conventionally, the IDs and passwords are formed by composition of English letters and figures (e.g., alphanumeric characters), and may be easily forgotten.

Additionally, since the users typically generates their IDs and passwords using private information, for example, a social security number, a date of birth, a telephone number, and information of a person related to the user, the conventional letter-based certification information is commonly related to the user's personal information. Therefore, others may be able to easily guess the certification information of the user. Consequently, there is a high possibility that a malicious user will misappropriate the user's certification information.

Further, in the current Internet age, since users have too many IDs and passwords as certification information, it is hard for the users to remember all of the IDs and passwords. If what the user inputs in the course of the user certification process is readily captured, the user certification information may be easily misappropriated.

### SUMMARY OF THE INVENTION

The present invention provides a user certification apparatus and method by which user certification information can be easily memorized by a user and not readily misappropriated by other users.

According to an aspect of the present invention, there is provided a user certification apparatus including a user certification unit performing user certification based on a combined result of avatar elements, which is indicated as identification information for identifying each avatar element, and position information that indicates a position of each avatar element on a combined avatar image.

The user certification unit may include: a randomizer for randomly changing an order of the avatar elements and providing the changed order of the avatar elements to an output unit; and a certification information comparing unit for performing user certification by comparing a combined result of avatar elements, which a user inputs from a selection of avatar elements displayed on the output unit, with user certification information previously stored by the user.

The combined result of the avatar elements, which the user inputs for user certification, may be received from the user through a communication network.

The user certification apparatus may further include a user certification information registration unit for registering the combined result of avatar elements, which the user selects to use as the user certification information.

According to another aspect of the present invention, there is provided a user certification method that performs user certification based on a combined result of avatar elements, which is indicated as identification information for identifying each avatar element, and position information that indicates a position of each avatar element on a combined avatar image.

According to still another aspect of the present invention, there is provided a computer readable recording medium having embodied thereon a computer program executing a user certification method, the method including: performing user certification based on a combined result of avatar elements, which is indicated as identification information for identifying each avatar element, and position information that indicates a position of each avatar element on a combined avatar image.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a user certification apparatus according to the prior art;

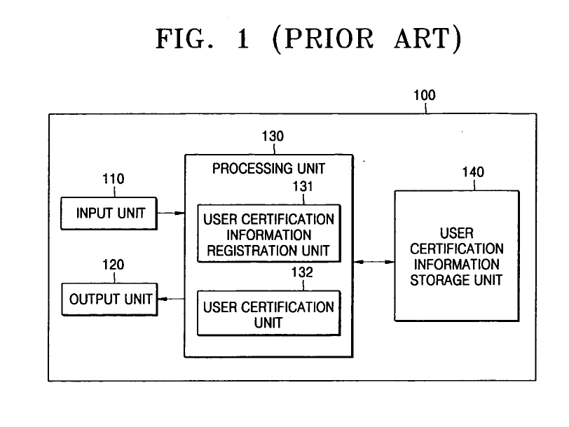

FIG. 2 is a flowchart of a user certification method according to the prior art;

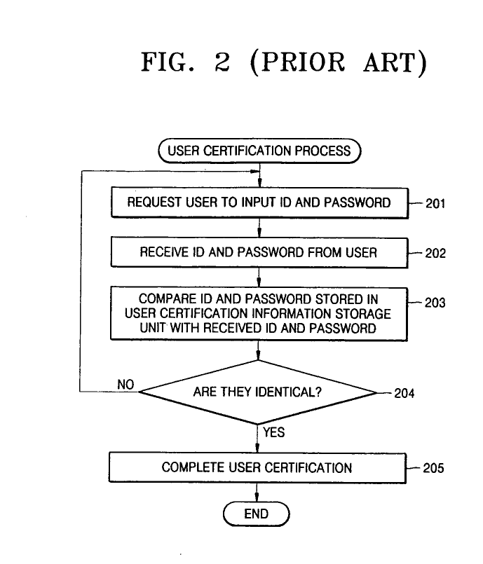

FIG. 3 is an example showing a user interface for performing user certification according to an exemplary embodiment of the present invention;

FIG. 4 is an example showing an avatar image which a user generates by combining avatar elements shown in FIG. 3;

FIG. 5 is an example showing a user interface in which the order of the avatar elements of FIG. 3 is randomized;

FIG. 6 is another example showing an avatar image which the user generates by combining the avatar elements shown in FIG. 3;

FIG. 7 is a block diagram of user certification apparatus according to another exemplary embodiment of the present invention;

FIG. 8 is a reference diagram for explaining contents of user certification information stored in a user certification information database illustrated in FIG. 7;

FIG. 9 is a flowchart showing procedures of registering user certification information according to still another exemplary embodiment of the present invention; and

FIG. 10 is a flowchart showing user certifying procedures according to yet another embodiment of the present invention.

### DETAILED DESCRIPTION OF THE EXEMPLARY EMBODIMENTS

The present invention now will be described more fully with reference to the accompanying drawings, in which illustrative embodiments of the invention are shown.

The word “avatar,” which means “self” or “incarnation,” is currently used for representing a user in cyberspace. With the coming of the Internet age, users need to express themselves on an on-line, three-dimensional (3D) or virtual reality (VR) game site or when chatting on the web. As such, an avatar can be a virtual body, that is, a graphic icon of the user for representing him/herself in a graphic-based virtual community. The avatar is, for example, an animated character or an image object, such as an animal, a plant, a house, or a car.

In most game or chatting services, service providers generally supply already-made avatars and items of characters with improved graphics technology, which can then be used by a user to create his/her own avatar showing the user's individuality. The conventional avatars are mostly two-dimensional (2D) graphics.

In a user password creating method according to the prior art, the password is created based on personal information of the user, private information of a person related to the user or a specific number such as an anniversary or a telephone number. Thus, others can easily guess the user's password. However, it is impossible to find out a password based on features of an avatar which is generated based on a user's own model.

Further, in a letter-based user password input method according to the prior art, the password should be input by fixed-type means such as a keyboard. However, a password based on features of an avatar can be flexibly input by functions of other input means, such as a drag operation using a mouse.

In the letter-based user password input method, the order of inputting the letters forming the password is very important. Conversely, with a password based on an avatar, only position information related to the items of the avatar is important, and the input order does not matter.

Additionally, in the letter-based user password input method, details of the user password can be hacked using a spy program. However, even if movements of a mouse or a keyboard used for the password based on features of an avatar are hacked by such a spy program, since the positions of the items of the avatar for the password are variable, necessary details of the password cannot be easily discovered.

Furthermore, in the letter-based user password input method, since the password contains for example between six letters and twelve letters, a user cannot remember the password when arbitrarily choosing the letters of the password. On the contrary, since an avatar is image information, a user can easily remember a password based on visual perception, which only takes approximately 80% of the user's perception.

In addition, in the method of inputting a password using an avatar, a user can have fun by virtually feeding the avatar with password items of the avatar when the items are developed rather than inputting the password as in a conventional operation.

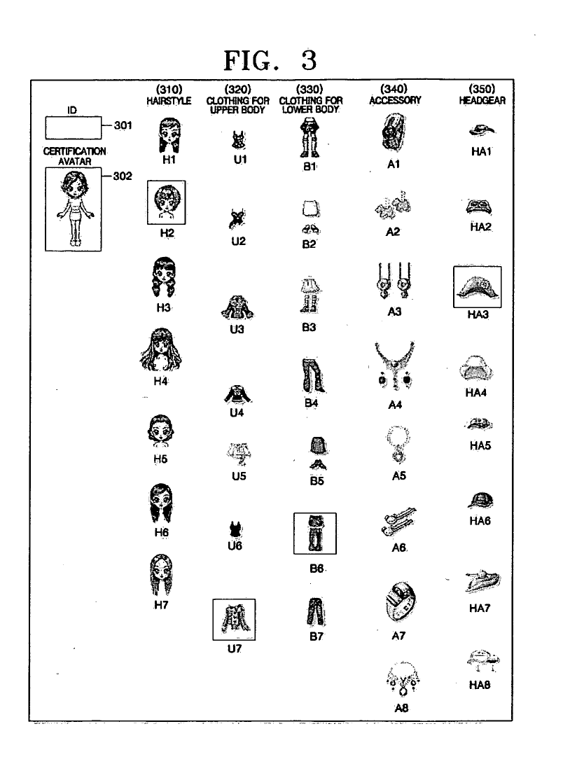

FIG. 3 is an example of a user interface for performing user certification according to an exemplary embodiment of the present invention.

Referring to FIG. 3, the user interface can be used when registering user certification information or when performing the user certification after registering the user certification information.

A portion for inputting identification (ID) 301 and a portion for generating a certification avatar 302 are placed in the left upper side of the user interface.

Avatar elements are arranged in the right side of the user interface.

The avatar elements are classified in groups, for example, a hairstyle 310, clothing for upper body 320, clothing for lower body 330, an accessory 340, and a headgear 350. The hairstyle 310 includes seven elements H1, H2, H3, H4, H5, H6 and H7, the clothing for upper body 320 includes seven elements U1, U2, U3, U4, U5, U6 and U7, and the clothing for lower body 330 includes seven elements B1, B2, B3, B4, B5, B6 and B7. The accessory 340 includes eight elements A1, A2, A3, A4, A5, A6, A7, and A8, and the headgear 350 includes eight elements HA1, HA2, HA3, HA4, HA5, HA6, HA7 and HA8. As shown in FIG. 3, the user interface includes images of respective avatar elements, and the identification information is shown below each of the images for convenience. The identification information, as information for identifying each of the avatar elements, is in effect used during the user certification operation in a device for performing the user certification.

More or fewer groups may be used, with more or fewer elements in each group.

A user inputs his/her ID in the portion for the ID 301, and generates an intended avatar image in a portion for the certification avatar 302 by selecting and dragging one or more items from the avatar elements in the right side of the user interface.

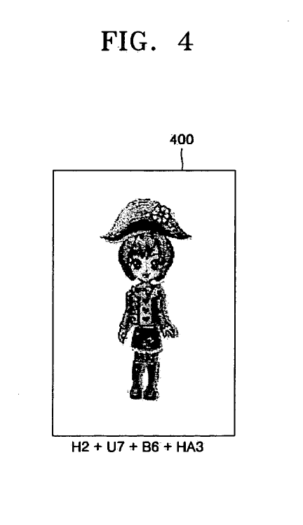

For example, when the user selects the element H2 from the hairstyle 310, the element U7 from the clothing for upper body 320, the element B6 from the clothing for lower body 330, and the element HA3 from the headgear 350, a generated image 400 obtained by combining the selected avatar elements is shown in FIG. 4. When the user selects the avatar elements H2, U7, B6, and HA3, the user can see the generated image 400 of FIG. 4, but the information to be actually used for the user certification is “H2+U7+B6+HA3,” which is the combination of each identification information for the selected avatar elements.

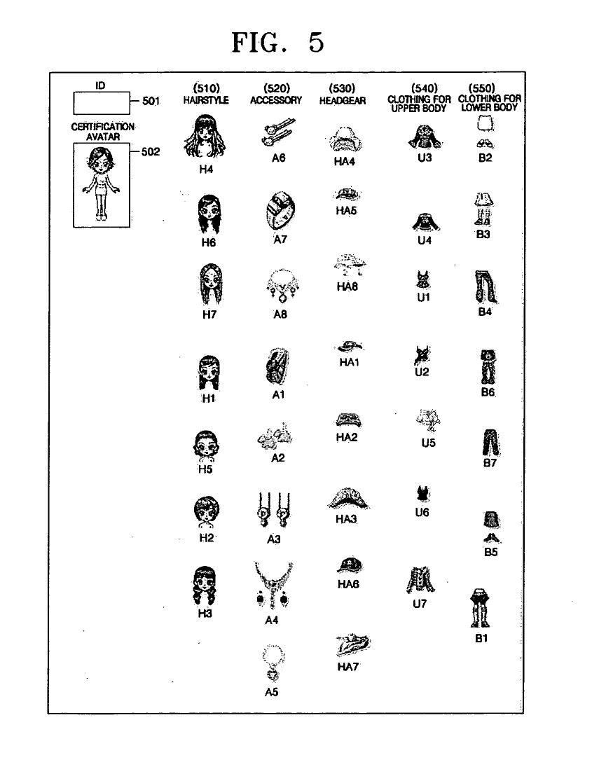

FIG. 5 is an example of a user interface in which the orders of the avatar elements shown in FIG. 3 are randomly arranged.

To prevent malicious users from hacking the information used for the user certification, it is preferable to randomly arrange the order of the avatar elements, which are used for input of certification information, in the user interface every time when inputting the certification information. In other words, if the order of the avatar elements, which are used for input of certification information and are output to the user interface, is always the same when inputting the certification information, there is a strong possibility that malicious users can steal information about the order of the elements and misappropriate the certification information. Therefore, it is preferable to randomly arrange the order of the avatar elements, which are used for input of certification information, and then output them to the user interface.

Referring to FIG. 5, among the avatar groups the hairstyle 510 is firstly placed, and the rest of the groups are arranged in the order of the accessory 520, the headgear 530, the clothing for upper body 540 and the clothing for lower body 550. The order of the groups can be different in the user interface by randomly arranging the order. Further, the order of the elements included in each group is changeable. Referring to the hairstyle 510, the elements are placed in the order of H4, H6, H7, H1, H5, H2 and H3, which is different than the order of the elements in the hairstyle 310 shown in FIG. 3.

Meanwhile, in the combination of avatar elements shown in FIG. 4, only element identification information is considered. However, when selecting an element, for example a “ring,” not only is the identification information of the ring considered, but position information indicating on which finger the ring is placed can also be considered. The certification information is generated by adding the position information of each avatar element to the identification information, and accordingly the security is increased.

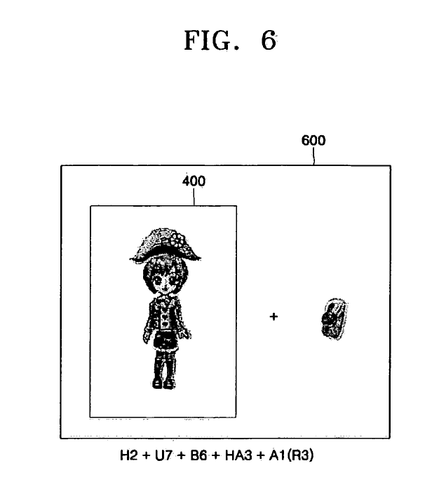

FIG. 6 is another example of an avatar image which is formed by combining some of the avatar elements shown in FIG. 3.

Referring to FIG. 6, the avatar is customized by adding a ring with identification information of A1 to the avatar 400 formed from the combination of the avatar elements shown in FIG. 4. The ring can be worn on any finger of either hand. Therefore, when a ring is added to the avatar, the position information of the ring can be one of ten pieces of position information right (R)1, R2, R3, R4, R5, left (L)1, L2, L3, L4 and L5.

For example, when a ring with identification information of A1 is selected and worn on the third finger of the right hand as shown in FIG. 6, the certification information formed by combining the identification information of the avatar elements with the position information of the ring is H2+U7+B6+HA3+A1(R3).

In FIG. 6, although the “ring” is used as an element having position information, any other element of the avatar images, whose position is changeable, can be used for the position information. Further, as described above, since the avatar is not limited to a human-appearance, when, for example, the avatar is related to a house, such an element as a vase, which is to be placed on some portion of the house, may be used for the position information.

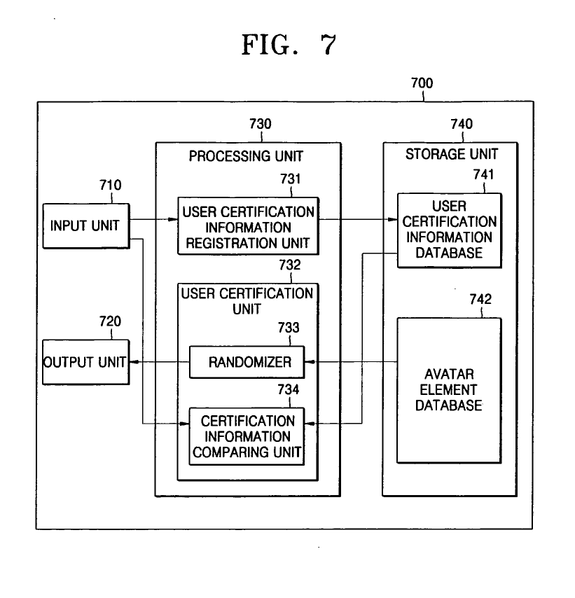

FIG. 7 is a diagram of a user certification apparatus 700 according to an exemplary embodiment of the present invention.

Referring to FIG. 7, the user certification apparatus include an input unit 710, an output unit 720, a processing unit 730, and a storage unit 740.

The input unit 710 receives inputs by users. Various input devices such as a keyboard, a mouse, and a keypad may be used as the input unit 710. In particular, in the present invention, since the user certification information is not input with characters but by selecting and dragging images of avatar elements, a mouse may be specifically used.

The output unit 720 is a display device which provides a user interface screen for showing a processed result by the processing unit 730, and outputs an image of user certification information registration or an image of user certification according to an embodiment of the present invention.

The processing unit 730 registers the user certification information according to a user's request, and can thereafter perform user certification.

When a user certification information registration unit 731 receives a combined result of avatar elements, each element being selected for use as the certification information, according to the user's request for registration of the user certification information, the user certification information registration unit 731 stores the combined result in a user certification information database 741.

A user certification unit 732 performs the user certification to allow an already registered user to use a predetermined service. The user certification unit 732 includes a randomizer 733 and a certification information comparing unit 734.

The randomizer 733 receives the avatar elements from an avatar element database 742, randomly changes the order of the avatar elements, and outputs the order-changed avatar elements to the output unit 720.

When the user inputs an image to be used for user certification information, which is formed by selecting and combining avatar elements from the avatar elements displayed by the output unit 720, the certification information comparing unit 734 compares the combined result of the avatar elements received from the user with the certification information of the user which is stored in the user certification information database 741. When the combined result and the stored certification information are identical, the user certification unit 732 completes the user certification and allows the user to use the service. When the combined result and the stored certification information are not same, the user certification unit 732 performs the user certification again. If, despite attempting the user certification several times, the result received from the user and the stored user certification information are not identical, the user certification unit decides that the user is a non-certified user and prevents use of the service.

The storage unit 740 is configured to store user certification information and avatar elements, and includes a storage medium, such as a HDD, a RAM, etc., or a data server of a remote site in case of a network environment.

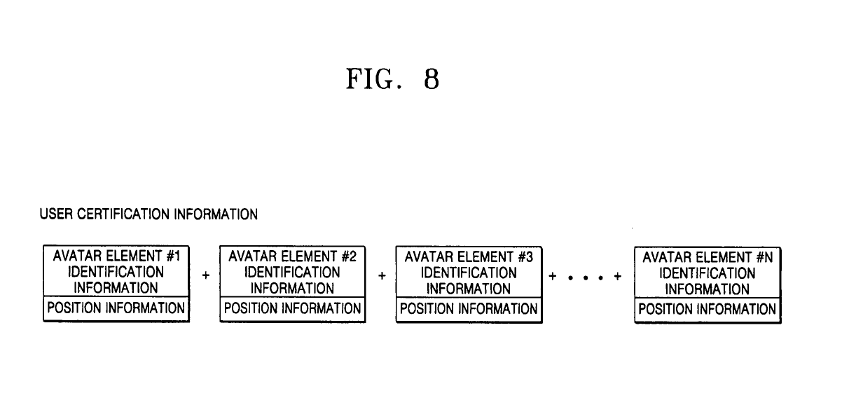

The user certification information database 741 stores the combined result of the avatar elements which the user inputs for use as the configuration information. In particular, the user certification information is composed of information about each avatar element included in the composition of the avatar elements, which the user inputs as the user's certification information as shown in FIG. 8. The information about each avatar element is composed of avatar element identification information and position information. Referring to FIG. 8, the user certification information includes identification information and position information of avatar element #1, identification information and position information of avatar element #2, identification information and position information of avatar element #3, . . . , and identification information and position information of avatar element #N. The identification information is for identifying each avatar element, and the position information is for indicating the position of each avatar element. Every avatar element should have the identification information, but the position information may be included or not included for an avatar element depending on the feature of the avatar element.

The avatar element database 742 stores groups of avatar elements from which the user selects the avatar elements to be used for the user certification.

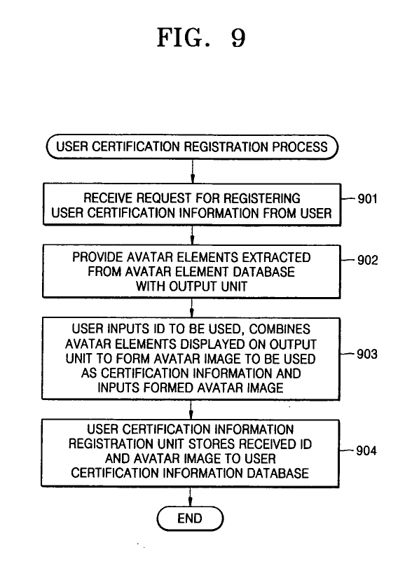

FIG. 9 is a flowchart showing procedures of registering the user certification information according to an exemplary embodiment of the present invention.

Referring to FIG. 9, a request for registration of user certification information is received from a user (operation 901).

Next, when receiving the request for registration, the user certification information registration unit 731 extracts avatar elements from the avatar element database 742 and provides the extracted avatar elements to the output unit 720 (operation 902).

The user watches a user interface screen provided on the output unit 720, and inputs his/her ID to be used as the certification information and also an image to be used as the certification information, the image being formed by combining avatar elements selected from those displayed on the output unit 720 (operation 903).

Then, the user certification information registration unit 731 stores the input ID and combined result of the avatar elements to the user certification information database 741 (operation 904). The image of the combined avatar elements is not practically stored, but the identification information and position information about each avatar element composing the image are stored or information in which the identification and position information are encoded is stored. Through these operations, the registration of the user certification information is completed.

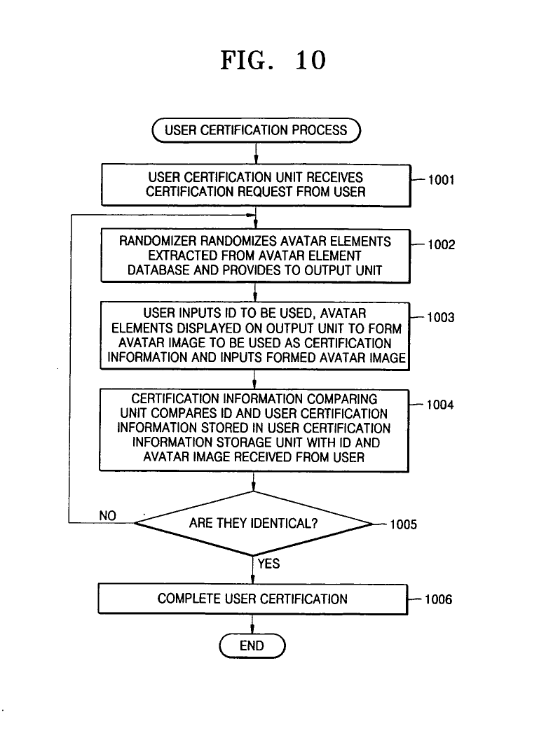

FIG. 10 is a flowchart of procedures of a user certification according to an embodiment of the present invention.

Referring to FIG. 10, the user certification unit 732 receives a user certification request from the user (operation 1001).

Next, the randomizer 733 in the user certification unit 732 randomizes the avatar elements extracted from the avatar element database 742, and provides the randomized avatar elements to the output unit 720 (operation 1002).

The user watches the avatar elements displayed on the output unit 720, combines selected avatar elements to complete the avatar image for use as the certification information, and inputs the completed avatar image and ID (operation 1003).

The certification information comparing unit 734 compares the input ID with the ID stored in the user certification information storage unit and the combined result of avatar elements with the user certification information stored in the user certification information storage unit, respectively (operation 1004).

It is determined if the IDs and the combined result and the stored certification information are identical with each other (operation 1005). When the respective IDs and the combined result and stored information are determined not to be identical with each other, the procedure goes back to the operation 1002 such that the user can input the user certification information again. When the IDs and information are determined to be identical with each other, the user certification is finished (operation 1006). That is, the user is allowed to use the service.

The invention can also be embodied as computer readable codes on a computer readable recording medium. The computer readable recording medium is any data storage device that can store data which can thereafter be read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, in a user certification method for information technology (IT) devices, visual features of an avatar are used as certification information. Therefore a user can more easily memorize and remember the user certification information.

Further, even if position information for each avatar element, which is input through an input device, is captured, the position information cannot be readily misappropriated even when the physical positions of the avatar elements are easily remembered since the avatar elements are provided after being randomized.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A user certification apparatus comprising:
a user certification unit that performs user certification based on user certification information including a plurality of avatar elements selected by a user to form an avatar image, which is indicated as identification information for identifying each avatar element in the avatar image.

2. The user certification apparatus of claim 1, wherein said user certification information further includes position information for indicating a position of at least one of the selected avatar elements on the avatar image.

3. The user certification apparatus of claim 1, wherein the user certification unit includes:
a randomizer that randomly changes an order of a plurality of avatar elements and provides the changed order of the avatar elements to an output unit; and
a certification information comparing unit that performs user certification by comparing a combined result of avatar elements, which the user inputs from the avatar elements displayed on the output unit, with user certification information previously stored by the user.

4. The user certification apparatus of claim 3, wherein the combined result of the avatar elements, which the user inputs, is received from the user through a communication network.

5. The user certification apparatus of claim 1, further comprising a user certification information registration unit that registers a combined result of avatar elements, which the user selects, as the user certification information.

6. The user certification apparatus of claim 1, further comprising a user certification information registration unit that registers the identification information.

7. A user certification method comprising:
performing user certification based on user certification information including a plurality of avatar elements selected by a user to form an avatar image, which is indicated as identification information for identifying each avatar element in the avatar image.

8. The user certification method of claim 7, wherein said user certification information further includes position information for indicating a position of at least one of the selected avatar elements on the avatar image.

9. The user certification method of claim 7, wherein the performing of user certification comprises:
providing a plurality of avatar elements to an output unit after randomly changing an order of the avatar elements; and
performing user certification by comparing a combined result of avatar elements, which the user inputs from the avatar elements displayed on the output unit, with user certification information previously stored by the user.

10. The user certification method of claim 9, wherein the combined result of avatar elements, which the user inputs, is received from the user through a communication network.

11. The user certification method of claim 7, further comprising registering a combined result of avatar elements, which the user selects, as the user certification information.

12. A computer readable recording medium having embodied thereon a computer program executing a user certification method, the method comprising:
performing user certification based on user certification information including a plurality of avatar elements selected by a user to form an avatar image, which is indicated as identification information for identifying each avatar element in the avatar image.

13. The computer readable medium of claim 12, wherein said user certification information further includes position information for indicating a position of one or more of the selected avatar elements on the avatar image.

14. The computer readable medium of claim 12, wherein the performing of user certification comprises:
providing a plurality of avatar elements to an output unit after randomly changing an order of the avatar elements; and
performing user certification by comparing a combined result of avatar elements, which the user inputs from the avatar elements displayed on the output unit, with user certification information previously stored by the user.

15. The computer readable medium of claim 14, wherein the combined result of avatar elements, which the user inputs, is received from the user through a communication network.

16. The computer readable medium of claim 12, wherein the user certification method further comprises registering a combined result of avatar elements, which the user selects, as the user certification information.
